(19) United States
(12) Patent Application Publication
(10) Pub. No.: US 2026/0356425 A1
(43) Pub. Date: Nov. 12, 2026

(54) VEHICLE DRIVING ASSISTANCE APPARATUS, VEHICLE DRIVING ASSISTANCE METHOD, AND STORAGE MEDIUM STORING VEHICLE DRIVING ASSISTANCE PROGRAM

(71) Applicants: TOYOTA JIDOSHA KABUSHIKI KAISHA, Aichi (JP); DENSO CORPORATION, Aichi-pref. (JP)

(72) Inventor: Hajime NAGAE, Toyota-shi (JP)

(21) Appl. No.: 19/660,088

(22) Filed: Apr. 27, 2026

(30) Foreign Application Priority Data
May 7, 2025 (JP) 2025-077139

(51) Int. Cl. B62D 6/08; B62D 15/02

(52) U.S. Cl. CPC B62D 6/08; B62D 15/025

(57) ABSTRACT

A vehicle driving assistance apparatus executes a departure suppression control of suppressing a departure of an own vehicle from a traveling lane. When the operator steering torque becomes equal to or greater than the predetermined threshold, the apparatus does not execute the control while the control is not executed, even when there is a possibility that the own vehicle departs from the traveling lane, and stops the control while the control is executed. The apparatus sets a reference threshold as the predetermined threshold when the control is not executed, sets a first threshold as the predetermined threshold applied to the opposite-phase operator steering torque when the control is executed, and sets a second threshold as the predetermined threshold applied to the in-phase operator steering torque when the control is executed. The reference threshold, the first threshold, and the second threshold are set to different values from each other.

### CROSS-REFERENCE TO RELATED APPLICATIONS

This application claims priority to Japanese patent application No. JP 2025-077139 filed on May 7, 2025, the content of which is hereby incorporated by reference in its entirety.

### BACKGROUND

### Field

The present invention relates to a vehicle driving assistance apparatus, a vehicle driving assistance method, and a storage medium storing a vehicle driving assistance program.

### Description of the Related Art

There is known a vehicle driving assistance apparatus which executes a departure suppression control of suppressing a departure of an own vehicle from a traveling lane by autonomously inputting, to a steering mechanism of the own vehicle, a departure suppression torque which is a steering torque in a direction opposite to an operator steering torque. Here, the operator steering torque is a steering torque that an operator of the own vehicle inputs to the steering mechanism.

Further, there is also known a vehicle driving assistance apparatus configured to stop the departure suppression control when the operator steering torque becomes equal to or greater than a predetermined torque threshold during execution of the departure suppression control (for example, see Japanese Patent Laid-Open No. 2023-3036).

For example, when the departure suppression control is started while an operator of the own vehicle is unconsciously inputting a counterclockwise steering torque to the steering mechanism, a clockwise departure suppression torque is autonomously input to the steering mechanism. At this time, the operator of the own vehicle may unconsciously increase the steering torque input to the steering mechanism. Therefore, there is a possibility that the counterclockwise operator steering torque becomes equal to or greater than a predetermined torque threshold and the departure suppression control is stopped. According to this, since the clockwise departure suppression torque is not input to the steering mechanism, there is a possibility that the own vehicle largely departs from the traveling lane.

### SUMMARY

An object of the present invention is to provide a vehicle driving assistance apparatus, a vehicle driving assistance method, and a storage medium storing a vehicle driving assistance program which are capable of appropriately performing execution and continuation of the departure suppression control and stopping of the departure suppression control.

A vehicle driving assistance apparatus according to the present invention comprises an electronic control unit which executes a departure suppression control of suppressing a departure of an own vehicle from a traveling lane by autonomously inputting, to a steering mechanism of the own vehicle, a departure suppression torque which is a steering torque in a direction opposite to an operator steering torque input to the steering mechanism by an operator of the own vehicle. The electronic control unit is configured to not execute the departure suppression control when the operator steering torque becomes equal to or greater than a predetermined prohibition torque threshold while the departure suppression control is not executed, even when there is a possibility that the own vehicle departs from the traveling lane, and stop the departure suppression control when the operator steering torque becomes equal to or greater than the predetermined prohibition torque threshold while the departure suppression control is executed.

The electronic control unit is configured to set a reference prohibition torque threshold as the predetermined prohibition torque threshold when the departure suppression control is not executed, set a first prohibition torque threshold as the predetermined prohibition torque threshold applied to the operator steering torque in a direction opposite to the departure suppression torque when the departure suppression control is executed, and the operator steering torque is a steering torque in a direction opposite to the departure suppression torque, and set a second prohibition torque threshold as the predetermined prohibition torque threshold applied to the operator steering torque in the same direction as the departure suppression torque when the departure suppression control is executed, and the operator steering torque is a steering torque in the same direction as the departure suppression torque. The reference prohibition torque threshold, the first prohibition torque threshold, and the second prohibition torque threshold are set to different values from each other.

According to the vehicle driving assistance apparatus according to the present invention, a value of a predetermined prohibition torque threshold is different among a case where the departure suppression control is not executed, a case where the departure suppression control is executed and the operator steering torque and the departure suppression torque are steering torques in opposite directions, and a case where the departure suppression control is executed and the operator steering torque and the departure suppression torque are steering torques in the same direction. Therefore, according to a situation, the departure suppression control can be continued or stopped. Accordingly, execution and continuation of the departure suppression control and stopping of the departure suppression control can be appropriately performed.

In the vehicle driving assistance apparatus according to an aspect of the present invention, the first prohibition torque threshold may be set to a value larger than the reference prohibition torque threshold, and the second prohibition torque threshold may be set to a value smaller than the reference prohibition torque threshold.

For example, when the own vehicle is about to depart from the traveling lane and the departure suppression control is started while the operator of the own vehicle is unconsciously inputting a counterclockwise steering torque to the steering mechanism, a clockwise departure steering torque is input to the steering mechanism. At this time, the operator of the own vehicle may unconsciously increase the steering torque input to the steering mechanism. Therefore, there is a possibility that the counterclockwise operator steering torque becomes equal to or greater than the predetermined prohibition torque threshold and the departure suppression control is stopped.

However, at this time, according to the vehicle driving assistance apparatus according to this aspect of the present invention, the first prohibition torque threshold is set as the predetermined prohibition torque threshold applied to the counterclockwise operator steering torque. Accordingly, the predetermined prohibition torque threshold applied to the counterclockwise operator steering torque becomes large. Therefore, the counterclockwise operator steering torque is less likely to become equal to or greater than the predetermined prohibition torque threshold, and the departure suppression control is less likely to be stopped. Therefore, according to a situation, the departure suppression control can be continued or stopped. Accordingly, execution and continuation of the departure suppression control and stopping of the departure suppression control can be appropriately performed.

Further, after the own vehicle is about to depart from the traveling lane and the departure suppression control is started while the operator of the own vehicle is unconsciously inputting a counterclockwise steering torque to the steering mechanism, when the operator of the own vehicle inputs a clockwise steering torque to the steering mechanism in order to avoid a departure of the own vehicle from the traveling lane by himself or herself, according to the vehicle driving assistance apparatus according to this aspect of the present invention, the second prohibition torque threshold is set as the predetermined prohibition torque threshold applied to the clockwise operator steering torque. Accordingly, the predetermined prohibition torque threshold applied to the clockwise operator steering torque becomes small. Therefore, the clockwise operator steering torque is likely to become equal to or greater than the predetermined prohibition torque threshold, and the departure suppression control is likely to be stopped. Therefore, according to a situation, the departure suppression control can be continued or stopped. Accordingly, execution and continuation of the departure suppression control and stopping of the departure suppression control can be appropriately performed.

A vehicle driving assistance method according to the present invention is a method of executing a departure suppression control of suppressing a departure of an own vehicle from a traveling lane by autonomously inputting, to a steering mechanism of the own vehicle, a departure suppression torque which is a steering torque in a direction opposite to an operator steering torque input to the steering mechanism by an operator of the own vehicle. The vehicle driving assistance method comprises steps of not executing the departure suppression control when the operator steering torque becomes equal to or greater than a predetermined prohibition torque threshold while the departure suppression control is not executed, even when there is a possibility that the own vehicle departs from the traveling lane, and stopping the departure suppression control when the operator steering torque becomes equal to or greater than the predetermined prohibition torque threshold while the departure suppression control is executed.

The vehicle driving assistance method further comprises steps of setting a reference prohibition torque threshold as the predetermined prohibition torque threshold when the departure suppression control is not executed, setting a first prohibition torque threshold as the predetermined prohibition torque threshold applied to the operator steering torque in a direction opposite to the departure suppression torque when the departure suppression control is executed, and the operator steering torque is a steering torque in a direction opposite to the departure suppression torque, and setting a second prohibition torque threshold as the predetermined prohibition torque threshold applied to the operator steering torque in the same direction as the departure suppression torque when the departure suppression control is executed, and the operator steering torque is a steering torque in the same direction as the departure suppression torque. The reference prohibition torque threshold, the first prohibition torque threshold, and the second prohibition torque threshold are set to different values from each other.

According to the vehicle driving assistance method according to the present invention, for the same reason as the above-described reason, execution and continuation of the departure suppression control and stopping of the departure suppression control can be appropriately performed.

A computer-readable non-transitory storage medium according to the present invention stores a vehicle driving assistance program which executes a departure suppression control of suppressing a departure of an own vehicle from a traveling lane by autonomously inputting, to a steering mechanism of the own vehicle, a departure suppression torque which is a steering torque in a direction opposite to an operator steering torque input to the steering mechanism by an operator of the own vehicle. The vehicle driving assistance program is configured to not execute the departure suppression control when the operator steering torque becomes equal to or greater than a predetermined prohibition torque threshold while the departure suppression control is not executed, even when there is a possibility that the own vehicle departs from the traveling lane, and stop the departure suppression control when the operator steering torque becomes equal to or greater than the predetermined prohibition torque threshold while the departure suppression control is executed.

The vehicle driving assistance program is configured to set a reference prohibition torque threshold as the predetermined prohibition torque threshold when the departure suppression control is not executed, set a first prohibition torque threshold as the predetermined prohibition torque threshold applied to the operator steering torque in a direction opposite to the departure suppression torque when the departure suppression control is executed, and the operator steering torque is a steering torque in a direction opposite to the departure suppression torque, and set a second prohibition torque threshold as the predetermined prohibition torque threshold applied to the operator steering torque in the same direction as the departure suppression torque when the departure suppression control is executed, and the operator steering torque is a steering torque in the same direction as the departure suppression torque. The reference prohibition torque threshold, the first prohibition torque threshold, and the second prohibition torque threshold are set to different values from each other.

According to the vehicle driving assistance program according to the present invention, for the same reason as the above-described reason, execution and continuation of the departure suppression control and stopping of the departure suppression control can be appropriately performed.

Constituent elements of the present invention are not limited to embodiments of the present invention described later with reference to the drawings. Other objects, other features, and accompanying advantages of the present invention will be readily understood from the description of the embodiments of the present invention.

### BRIEF DESCRIPTION OF THE DRAWINGS

FIG. 1 is a diagram showing a vehicle driving assistance apparatus according to an embodiment of the present invention.

FIG. 2 is a flowchart showing a routine executed by the vehicle driving assistance apparatus according to the embodiment of the present invention.

FIG. 3 is a flowchart showing a routine executed by the vehicle driving assistance apparatus according to the embodiment of the present invention.

FIG. 4 is a diagram showing a left lane marking distance and a right lane marking distance.

FIG. 5 is a diagram showing a scene in which a departure of the own vehicle from an own vehicle traveling lane is avoided by a departure suppression control.

FIG. 6 is a diagram showing a scene in which a lane change of the own vehicle is performed.

FIG. 7 is a diagram showing a scene in which a departure of the own vehicle from the own vehicle traveling lane is avoided by a driver.

### DETAILED DESCRIPTION

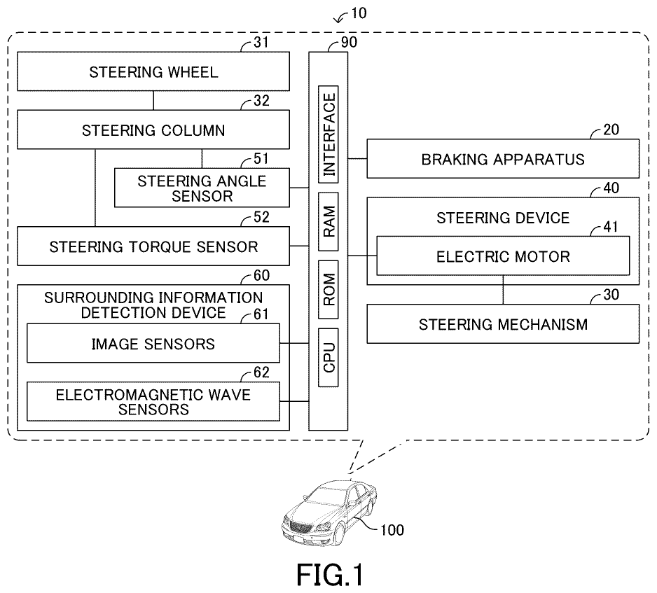

Below, a vehicle driving assistance apparatus, a vehicle driving assistance method, and a storage medium storing a vehicle driving assistance program according to an embodiment of the present invention will be described with reference to the drawings. FIG. 1 shows a vehicle driving assistance apparatus 10 according to the embodiment of the present invention. The vehicle driving assistance apparatus 10 is mounted on an own vehicle 100. Hereinafter, a case where an operator of the own vehicle 100 is a driver of the own vehicle 100 (that is, a person who gets in the own vehicle 100 and drives the own vehicle 100) will be described as an example to describe the vehicle driving assistance apparatus 10. However, the operator of the own vehicle 100 may be a remote operator of the own vehicle 100 (that is, a person who remotely drives the own vehicle 100 without getting in the own vehicle 100). It should be noted that, in the following description, the driver of the own vehicle 100 may be simply referred to as a “driver.”

As shown in FIG. 1, the vehicle driving assistance apparatus 10 includes an ECU (electronic control unit) 90 as a control device. The ECU 90 includes a microcomputer as a main part. The microcomputer includes a CPU, a computer-readable storage medium, an interface, and the like. The storage medium includes a ROM, a RAM, a non-volatile memory, and the like. The CPU realizes various functions by executing instructions or programs or routines stored in the storage medium. In particular, in the present example, the vehicle driving assistance apparatus 10 stores, in the storage medium, programs for realizing various controls executed by the vehicle driving assistance apparatus 10.

It should be noted that, in the present example, the vehicle driving assistance apparatus 10 includes only one ECU 90, but the vehicle driving assistance apparatus 10 may include a plurality of ECUs and may be configured such that the functions of the vehicle driving assistance apparatus 10 described below are shared and executed by the respective ECUs.

Further, the vehicle driving assistance apparatus 10 may be configured such that programs stored in the storage medium can be updated by wireless communication (for example, Internet communication) with external devices.

It should be noted that the vehicle driving assistance apparatus 10 is applied not only to a vehicle that travels by manual driving by an operator but also to a vehicle that travels by automatic driving in addition to manual driving.

The own vehicle 100 is provided with a braking apparatus 20, a steering mechanism 30, a steering wheel 31, a steering column 32, a steering device 40, a steering angle sensor 51, a steering torque sensor 52, and a surrounding information detection device 60.

The braking apparatus 20 applies a braking force to the own vehicle 100 (in particular, each wheel of the own vehicle 100) for braking the own vehicle 100. The braking apparatus 20 is electrically connected to the ECU 90. The vehicle driving assistance apparatus 10 applies a braking force to the own vehicle 100 by controlling an operation of the braking apparatus 20.

The steering mechanism 30 includes the steering column 32, an intermediate shaft, and a rack-and-pinion gear. The steering column 32 is connected to the steering wheel 31 and the intermediate shaft. That is, the steering column 32 connects the steering wheel 31 to the intermediate shaft. Further, the rack-and-pinion gear is connected to the intermediate shaft and steered wheels of the own vehicle 100. That is, the rack-and-pinion gear connects the intermediate shaft to the steered wheels of the own vehicle 100.

The steering wheel 31 is a device operated by the driver to steer the own vehicle 100. The steering wheel 31 is connected to the steering column 32. The driver can rotate the steering column 32 by rotationally operating the steering wheel 31.

The steering device 40 is a device which steers the own vehicle 100 by applying or inputting a steering torque for steering the own vehicle 100 to the steering mechanism 30. The steering device 40 includes an electric motor 41. The steering device 40 applies or inputs a steering torque from the electric motor 41 to the steering mechanism 30. In the present example, the steering device 40 applies or inputs a steering torque from the electric motor 41 to the steering column 32. However, the steering device 40 may be configured to apply or input a steering torque from the electric motor 41 to a pinion portion or a rack portion of the rack-and-pinion gear.

The steering angle sensor 51 is a sensor for detecting a steering angle θ. The steering angle θ is a rotation angle of the steering column 32 from a neutral position. The steering torque sensor 52 is a sensor for detecting a driver steering torque TQdrv. The driver steering torque TQdrv is a torque that the driver of the own vehicle 100 applies or inputs to the steering mechanism 30 (in particular, the steering column 32) via the steering wheel 31.

The steering device 40, the steering angle sensor 51, and the steering torque sensor 52 are electrically connected to the ECU 90. The vehicle driving assistance apparatus 10 acquires the steering angle θ by the steering angle sensor 51. Further, the vehicle driving assistance apparatus 10 acquires the driver steering torque TQdrv by the steering torque sensor 52. The vehicle driving assistance apparatus 10 controls an operation of the steering device 40 according to the steering angle θ and the driver steering torque TQdrv, thereby controlling a steering torque applied or input from the electric motor 41 to the steering mechanism 30.

The surrounding information detection device 60 is a device which detects information on surroundings of the own vehicle 100. The surrounding information detection device 60 includes a plurality of image sensors 61 and a plurality of electromagnetic wave sensors 62.

The image sensor 61 is a sensor which captures an image of the surroundings of the own vehicle 100. The image sensor 61 is, for example, a camera sensor. The image sensors 61 are electrically connected to the ECU 90. The vehicle driving assistance apparatus 10 acquires image information IC on the surroundings of the own vehicle 100 as surrounding information IS by the image sensors 61.

The electromagnetic wave sensor 62 is a sensor which acquires information on objects around the own vehicle 100. The electromagnetic wave sensor 62 is, for example, a millimeter wave radar. The electromagnetic wave sensors 62 are electrically connected to the ECU 90. The vehicle driving assistance apparatus 10 acquires object information IO on objects around the own vehicle 100 as surrounding information Is by the electromagnetic wave sensors 62.

### <Operation of Vehicle Driving Assistance Apparatus>

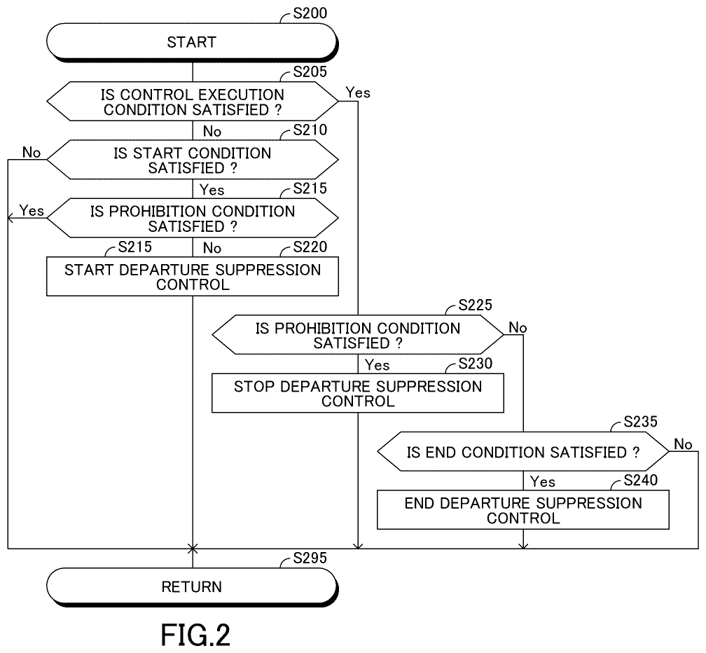

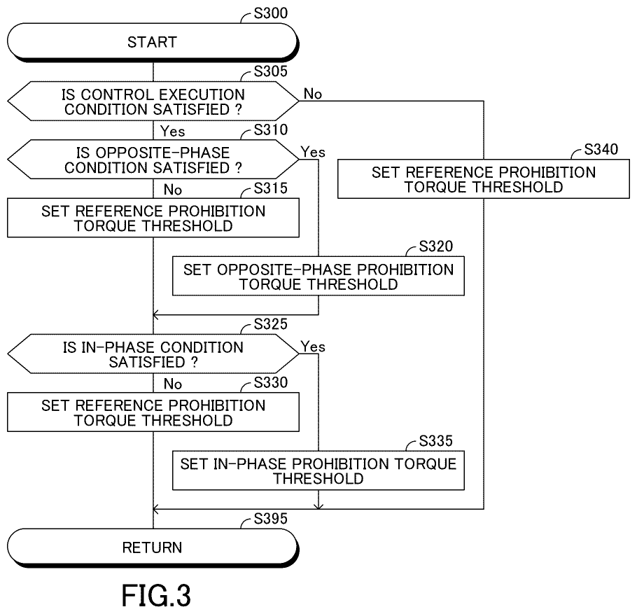

Next, an operation of the vehicle driving assistance apparatus 10 will be described. The vehicle driving assistance apparatus 10 executes routines shown in FIG. 2 and FIG. 3 at predetermined time intervals. Accordingly, the vehicle driving assistance apparatus 10 executes a departure suppression control when predetermined conditions are satisfied.

The departure suppression control is a control of suppressing a departure of the own vehicle 100 from an own vehicle traveling lane LN by autonomously inputting, to the steering mechanism 30 of the own vehicle 100, a departure suppression torque TQsup which is a steering torque in a direction opposite to the driver steering torque TQdrv.

More specifically, when a left lane marking distance DL becomes equal to or less than a predetermined distance Dthr and the departure suppression control is started, the departure suppression control is a control which applies, to the steering column 32, a departure suppression torque TQsup which turns the own vehicle 100 rightward. Therefore, the departure suppression torque TQsup here is a torque which rotates the steering column 32 in a direction to cause the own vehicle 100 to head toward a center of the own vehicle traveling lane LN.

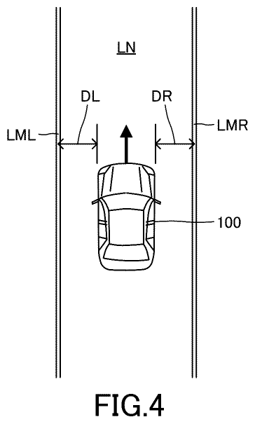

As shown in FIG. 4, the left lane marking distance DL is a distance between a left end of the own vehicle 100 and a left lane marking LML. The left lane marking LML is a lane marking which defines the own vehicle traveling lane LN and is provided on a left side of the own vehicle 100.

On the other hand, when a right lane marking distance DR becomes equal to or less than the predetermined distance Dthr and the departure suppression control is started, the departure suppression control is a control which applies, to the steering column 32, a departure suppression torque TQsup which turns the own vehicle 100 leftward. Therefore, the departure suppression torque TQsup here is also a torque which rotates the steering column 32 in a direction to cause the own vehicle 100 to head toward the center of the own vehicle traveling lane LN.

As shown in FIG. 4, the right lane marking distance DR is a distance between a right end of the own vehicle 100 and a right lane marking LMR. The right lane marking LMR is a lane marking which defines the own vehicle traveling lane LN and is provided on a right side of the own vehicle 100.

It should be noted that the vehicle driving assistance apparatus 10 applies the departure suppression torque TQsup to the steering column 32 by controlling an operation of the steering device 40. Further, the departure suppression torque TQsup is set to a value at which the driver of the own vehicle 100 can operate the steering wheel 31 against the departure suppression torque TQsup.

When a predetermined timing comes, the vehicle driving assistance apparatus 10 starts a process from a step S200 of the routine shown in FIG. 2. Then, the vehicle driving assistance apparatus 10 proceeds with the process to a step S205 to determine whether a control execution condition C1 is satisfied.

The control execution condition C1 is satisfied when the departure suppression control is executed. On the other hand, the control execution condition C1 is not satisfied when the departure suppression control is ended or stopped.

When the vehicle driving assistance apparatus 10 determines “No” at the step S205, the vehicle driving assistance apparatus 10 proceeds with the process to a step S210 to determine whether a start condition C2 is satisfied.

The start condition C2 is satisfied when the vehicle driving assistance apparatus 10 determines that the own vehicle 100 departs from the own vehicle traveling lane LN. In the present example, the vehicle driving assistance apparatus 10 determines that the own vehicle 100 departs from the own vehicle traveling lane LN when the left lane marking distance DL becomes equal to or less than the predetermined distance Dthr. Further, the vehicle driving assistance apparatus 10 determines that the own vehicle 100 departs from the own vehicle traveling lane LN when the right lane marking distance DR becomes equal to or less than the predetermined distance Dthr.

The vehicle driving assistance apparatus 10 acquires the left lane marking distance DL and the right lane marking distance DR based on the surrounding information IS (in particular, the image information IC).

It should be noted that, in the present example, the vehicle driving assistance apparatus 10 may be configured to acquire one or more parameters in addition to the left lane marking distance DL and the right lane marking distance DR, and to determine whether the own vehicle 100 departs from the own vehicle traveling lane LN based on the acquired one or more parameters and the left lane marking distance DL and the right lane marking distance DR. Here, the one or more parameters include, for example, the steering angle θ, a yaw rate of the own vehicle 100, a yaw angle of the own vehicle 100 with respect to an extending direction of the own vehicle traveling lane LN, and a lateral acceleration rate of the own vehicle 100. In this case, the vehicle driving assistance apparatus 10 acquires the yaw rate of the own vehicle 100 by a yaw rate sensor. Further, the vehicle driving assistance apparatus 10 acquires the yaw angle of the own vehicle 100 with respect to the extending direction of the own vehicle traveling lane LN based on the yaw rate of the own vehicle 100 and the image information IC. Further, the vehicle driving assistance apparatus 10 acquires the lateral acceleration rate of the own vehicle 100 by a lateral acceleration rate sensor.

When the vehicle driving assistance apparatus 10 determines “No” at the step S210, the vehicle driving assistance apparatus 10 proceeds with the process directly to a step S295 to terminate the process of this routine once. Therefore, in the present example, when the start condition C2 is not satisfied while the departure suppression control is not executed, the departure suppression control is not executed.

On the other hand, when the vehicle driving assistance apparatus 10 determines “Yes” at the step S210, the vehicle driving assistance apparatus 10 proceeds with the process to a step S215 to determine whether a prohibition condition C3 is satisfied.

In the present example, the prohibition condition C3 is satisfied when the driver steering torque TQdrv is a counterclockwise steering torque and an absolute value of the driver steering torque TQdrv becomes equal to or greater than a counterclockwise prohibition torque threshold TQccw. On the other hand, the prohibition condition C3 is not satisfied when the driver steering torque TQdrv is the counterclockwise steering torque and the absolute value of the driver steering torque TQdrv is less than the counterclockwise prohibition torque threshold TQccw. The counterclockwise prohibition torque threshold TQccw is a prohibition torque threshold TQthr applied to the counterclockwise driver steering torque TQdrv.

On the other hand, in the present example, the prohibition condition C3 is satisfied when the driver steering torque TQdrv is a clockwise steering torque and an absolute value of the driver steering torque TQdrv becomes equal to or greater than a clockwise prohibition torque threshold TQcw. On the other hand, the prohibition condition C3 is not satisfied when the driver steering torque TQdrv is the clockwise steering torque and the absolute value of the driver steering torque TQdrv is less than the clockwise prohibition torque threshold TQcw. The clockwise prohibition torque threshold TQcw is a prohibition torque threshold TQthr applied to the clockwise driver steering torque TQdrv.

When the vehicle driving assistance apparatus 10 determines “Yes” at the step S215, the vehicle driving assistance apparatus 10 proceeds with the process directly to the step S295 to terminate the process of this routine once.

As described above, when the driver steering torque TQdrv becomes equal to or greater than a predetermined prohibition torque threshold (that is, the counterclockwise prohibition torque threshold TQccw or the clockwise prohibition torque threshold TQcw) while the departure suppression control is not executed, the vehicle driving assistance apparatus 10 does not execute the departure suppression control even when there is a possibility that the own vehicle 100 departs from the own vehicle traveling lane LN. Therefore, when the prohibition condition C3 is satisfied, execution of the departure suppression control is prohibited.

On the other hand, when the vehicle driving assistance apparatus 10 determines “No” at the step S215, the vehicle driving assistance apparatus 10 proceeds with the process to a step S220 to start the departure suppression control. Next, the vehicle driving assistance apparatus 10 proceeds with the process to the step S295 to terminate the process of this routine once.

It should be noted that the vehicle driving assistance apparatus 10 may be configured to assist suppression of a departure of the own vehicle 100 from the own vehicle traveling lane LN by applying a braking force to the own vehicle 100 when executing the departure suppression control.

Further, the vehicle driving assistance apparatus 10 may be configured to ensure safety of the own vehicle 100 by adding the departure suppression torque TQsup in consideration of an object approaching the own vehicle 100 when executing the departure suppression control. Here, the object approaching the own vehicle 100 includes, for example, an oncoming vehicle with respect to the own vehicle 100, a vehicle trying to pass the own vehicle 100, and a vehicle parked in front of the own vehicle 100. It should be noted that the vehicle driving assistance apparatus 10 detects the object approaching the own vehicle 100 based on the surrounding information IS.

Further, the vehicle driving assistance apparatus 10 may be configured to notify the driver that there is a possibility that the own vehicle 100 departs from the own vehicle traveling lane LN by issuing an alarm to the driver when executing the departure suppression control. It should be noted that the alarm to the driver is realized by, for example, outputting an alarm sound from a speaker, displaying an alarm image on a meter display, and vibrating the steering wheel 31 by a vibrator.

Further, when the vehicle driving assistance apparatus 10 determines “Yes” at the step S205, the vehicle driving assistance apparatus 10 proceeds with the process to a step S225 to determine whether the prohibition condition C3 is satisfied.

When the vehicle driving assistance apparatus 10 determines “Yes” at the step S225, the vehicle driving assistance apparatus 10 proceeds with the process to a step S230 to stop the departure suppression control. Next, the vehicle driving assistance apparatus 10 proceeds with the process to THE step S295 to terminate the process of this routine once.

As described above, when the driver steering torque TQdrv becomes equal to or greater than a predetermined prohibition torque threshold (that is, the counterclockwise prohibition torque threshold TQccw or the clockwise prohibition torque threshold TQcw) while executing the departure suppression control, the vehicle driving assistance apparatus 10 stops the departure suppression control. Therefore, when the prohibition condition C3 is satisfied during execution of the departure suppression control, execution of the departure suppression control is prohibited.

On the other hand, when the vehicle driving assistance apparatus 10 determines “No” at the step S225, the vehicle driving assistance apparatus 10 proceeds with the process to a step S235 to determine whether an end condition C4 is satisfied.

The end condition C4 is satisfied when the left lane marking distance DL becomes greater than the predetermined distance Dthr after the departure suppression control is started due to the left lane marking distance DL becoming equal to or less than the predetermined distance Dthr. Further, the end condition C4 is satisfied when the right lane marking distance DR becomes greater than the predetermined distance Dthr after the departure suppression control is started due to the right lane marking distance DR becoming equal to or less than the predetermined distance Dthr.

Alternatively, the end condition C4 may be configured to be satisfied when the own vehicle 100 starts to travel along a center line CL of the own vehicle traveling lane LN after the departure suppression control is started due to the left lane marking distance DL becoming equal to or less than the predetermined distance Dthr. Further, in this case, the end condition C4 may be configured to be satisfied when the own vehicle 100 starts to travel along the center line CL of the own vehicle traveling lane LN after the departure suppression control is started due to the right lane marking distance DR becoming equal to or less than the predetermined distance Dthr. The center line CL of the own vehicle traveling lane LN is a line connecting intermediate points in a width direction of the own vehicle traveling lane LN.

When the vehicle driving assistance apparatus 10 determines “Yes” at the step S235, the vehicle driving assistance apparatus 10 proceeds with the process to a step S240 to end the departure suppression control. Next, the vehicle driving assistance apparatus 10 proceeds with the process to the step S295 to terminate the process of this routine once.

On the other hand, when the vehicle driving assistance apparatus 10 determines “No” at the step S235, the vehicle driving assistance apparatus 10 proceeds with the process directly to the step S295 to terminate the process of this routine once. In this case, the departure suppression control is continued.

Further, when a predetermined timing comes, the vehicle driving assistance apparatus 10 starts a process from a step S300 of the routine shown in FIG. 3. Then, the vehicle driving assistance apparatus 10 proceeds with the process to a step S305 to determine whether the control execution condition C1 is satisfied.

When the vehicle driving assistance apparatus 10 determines “Yes” at the step S305, the vehicle driving assistance apparatus 10 proceeds with the process to a step S310 to determine whether an opposite-phase condition C5 is satisfied.

In the present example, the opposite-phase condition C5 is satisfied when the departure suppression torque TQsup is a clockwise steering torque and the driver steering torque TQdrv is a counterclockwise steering torque. Further, the opposite-phase condition C5 is satisfied when the departure suppression torque TQsup is a counterclockwise steering torque and the driver steering torque TQdrv is a clockwise steering torque. That is, the opposite-phase condition C5 is satisfied when the driver steering torque TQdrv is an opposite-phase steering torque.

When the vehicle driving assistance apparatus 10 determines “No” at the step S310, the vehicle driving assistance apparatus 10 proceeds with the process to a step S315 to set a reference prohibition torque threshold TQbas as the prohibition torque threshold TQthr. Next, the vehicle driving assistance apparatus 10 proceeds with the process to a step S325.

It should be noted that, when the driver steering torque TQdrv at a time point when the process proceeds to the step S315 is a counterclockwise steering torque, the reference prohibition torque threshold TQbas is set as the counterclockwise prohibition torque threshold TQccw. On the other hand, when the driver steering torque TQdrv at the time point when the process proceeds to the step S315 is a clockwise steering torque, the reference prohibition torque threshold TQbas is set as the clockwise prohibition torque threshold TQcw.

It should be noted that, in the present example, the reference prohibition torque threshold TQbas is set to a minimum value of an absolute value of the driver steering torque TQdrv estimated to be generally applied to the steering wheel 31 when the driver changes a lane of the own vehicle 100.

On the other hand, when the vehicle driving assistance apparatus 10 determines “Yes” at the step S310, the vehicle driving assistance apparatus 10 proceeds with the process to a step S320 to set an opposite-phase prohibition torque threshold TQoph as the prohibition torque threshold TQthr. Next, the vehicle driving assistance apparatus 10 proceeds with the process to the step S325.

In the present example, the opposite-phase prohibition torque threshold TQoph is set to a value larger than the reference prohibition torque threshold TQbas by a predetermined value ΔTQup. The predetermined value ΔTQup is set to a value of a steering torque predicted to be increased by the driver when the departure suppression torque TQsup is added to the steering column 32, or to a value larger than the value.

It should be noted that, when the driver steering torque TQdrv at a time point when the process proceeds to the step S320 is a counterclockwise steering torque, the opposite-phase prohibition torque threshold TQoph is set as the counterclockwise prohibition torque threshold TQccw. On the other hand, when the driver steering torque TQdrv at the time point when the process proceeds to the step S320 is a clockwise steering torque, the opposite-phase prohibition torque threshold TQoph is set as the clockwise prohibition torque threshold TQcw.

As described above, when the departure suppression control is executed and the driver steering torque TQdrv is a steering torque in a direction opposite to the departure suppression torque TQsup, the vehicle driving assistance apparatus 10 sets a first prohibition torque threshold (that is, the opposite-phase prohibition torque threshold TQoph) as a predetermined prohibition torque threshold (that is, the counterclockwise prohibition torque threshold TQccw or the clockwise prohibition torque threshold TQcw) applied to the driver steering torque TQdrv in the direction opposite to the departure suppression torque TQsup.

When the vehicle driving assistance apparatus 10 proceeds with the process to the step S325, the vehicle driving assistance apparatus 10 determines whether an in-phase condition C6 is satisfied.

In the present example, the in-phase condition C6 is satisfied when the departure suppression torque TQsup is a counterclockwise steering torque and the driver steering torque TQdrv is a counterclockwise steering torque. Further, the in-phase condition C6 is satisfied when the departure suppression torque TQsup is a clockwise steering torque and the driver steering torque TQdrv is a clockwise steering torque. That is, the in-phase condition C6 is satisfied when the driver steering torque TQdrv is an in-phase steering torque.

When the vehicle driving assistance apparatus 10 determines “No” at the step S325, the vehicle driving assistance apparatus 10 proceeds with the process to a step S330 to set the reference prohibition torque threshold TQbas as the prohibition torque threshold TQthr. Next, the vehicle driving assistance apparatus 10 proceeds with the process to a step S395 to terminate the process of this routine once.

It should be noted that, when the driver steering torque TQdrv at a time point when the process proceeds to the step S330 is a counterclockwise steering torque, the reference prohibition torque threshold TQbas is set as the counterclockwise prohibition torque threshold TQccw. On the other hand, when the driver steering torque TQdrv at the time point when the process proceeds to the step S330 is a clockwise steering torque, the reference prohibition torque threshold TQbas is set as the clockwise prohibition torque threshold TQcw.

On the other hand, when the vehicle driving assistance apparatus 10 determines “Yes” at the step S325, the vehicle driving assistance apparatus 10 proceeds with the process to a step S335 to set an in-phase prohibition torque threshold TQiph as the prohibition torque threshold TQthr. Next, the vehicle driving assistance apparatus 10 proceeds with the process to the step S395 to terminate the process of this routine once.

In the present example, the in-phase prohibition torque threshold TQiph is set to a value smaller than the reference prohibition torque threshold TQbas by a predetermined value ΔTQdown. The predetermined value ΔTQdown is set to, for example, a value equal to the predetermined value ΔTQup.

It should be noted that, when the driver steering torque TQdrv at a time point when the process proceeds to the step S335 is a counterclockwise steering torque, the in-phase prohibition torque threshold TQiph is set as the counterclockwise prohibition torque threshold TQccw. On the other hand, when the driver steering torque TQdrv at the time point when the process proceeds to the step S335 is a clockwise steering torque, the in-phase prohibition torque threshold TQiph is set as the clockwise prohibition torque threshold TQcw.

As described above, when the departure suppression control is executed and the driver steering torque TQdrv is a steering torque in a same direction as the departure suppression torque TQsup, the vehicle driving assistance apparatus 10 sets a second prohibition torque threshold (that is, the in-phase prohibition torque threshold TQiph) as a predetermined prohibition torque threshold (that is, the counterclockwise prohibition torque threshold TQccw or the clockwise prohibition torque threshold TQcw) applied to the driver steering torque TQdrv in the same direction as the departure suppression torque TQsup.

In the present example, the reference prohibition torque threshold TQbas, the first prohibition torque threshold (that is, the opposite-phase prohibition torque threshold TQoph), and the second prohibition torque threshold (that is, the in-phase prohibition torque threshold TQiph) are set to different values from each other.

In particular, in the present example, the first prohibition torque threshold (that is, the opposite-phase prohibition torque threshold TQoph) is set to a value larger than the reference prohibition torque threshold TQbas. Further, the second prohibition torque threshold (that is, the in-phase prohibition torque threshold TQiph) is set to a value smaller than the reference prohibition torque threshold TQbas.

Further, when the vehicle driving assistance apparatus 10 determines “No” at the step S305, the vehicle driving assistance apparatus 10 proceeds with the process to a step S340 to set the reference prohibition torque threshold TQbas as the prohibition torque threshold TQthr. Next, the vehicle driving assistance apparatus 10 proceeds with the process to the step S395 to terminate the process of this routine once.

As described above, when the departure suppression control is not executed, the vehicle driving assistance apparatus 10 sets the reference prohibition torque threshold TQbas as predetermined prohibition torque thresholds (that is, the counterclockwise prohibition torque threshold TQccw and the clockwise prohibition torque threshold TQcw).

It should be noted that, in the step S340, the reference prohibition torque threshold TQbas is set as each of the counterclockwise prohibition torque threshold TQccw and the clockwise prohibition torque threshold TQcw.

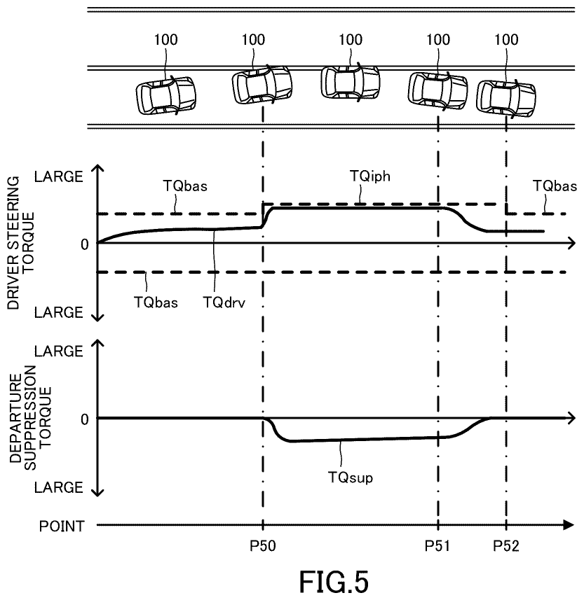

The above is the operation of the vehicle driving assistance apparatus 10. According to the vehicle driving assistance apparatus 10, in each of scenes shown in FIG. 5 to FIG. 7, the departure suppression control is executed or stopped as follows.

A scene shown in FIG. 5 is a scene in which the driver unconsciously applies a counterclockwise steering torque to the steering wheel 31. In the present example, the departure suppression control is started when the own vehicle 100 reaches a point P50. Accordingly, since a clockwise departure suppression torque TQsup is added to the steering column 32, the driver unconsciously increases the counterclockwise steering torque applied to the steering wheel 31.

At this time, when the reference prohibition torque threshold TQbas is set as the counterclockwise prohibition torque threshold TQccw, the prohibition condition C3 is satisfied and the departure suppression control is stopped. In this case, since the counterclockwise driver steering torque TQdrv is increased, there is a possibility that the own vehicle 100 largely departs from the own vehicle traveling lane LN.

However, according to the vehicle driving assistance apparatus 10, when the departure suppression control is started at the point P50, the opposite-phase prohibition torque threshold TQoph is set as the counterclockwise prohibition torque threshold TQccw. That is, the counterclockwise prohibition torque threshold TQccw is increased. Therefore, the prohibition condition C3 is less likely to be satisfied, and the departure suppression control is continued. Accordingly, it is possible to suppress the own vehicle 100 from largely departing from the own vehicle traveling lane LN.

It should be noted that, in the example shown in FIG. 5, the counterclockwise driver steering torque TQdrv starts to decrease when the own vehicle 100 reaches a point P51. Then, when the own vehicle 100 reaches a point P52, the end condition C4 is satisfied. Therefore, the departure suppression control is ended, and the departure suppression torque TQsup becomes zero. Further, the reference prohibition torque threshold TQbas is set as the counterclockwise prohibition torque threshold TQccw.

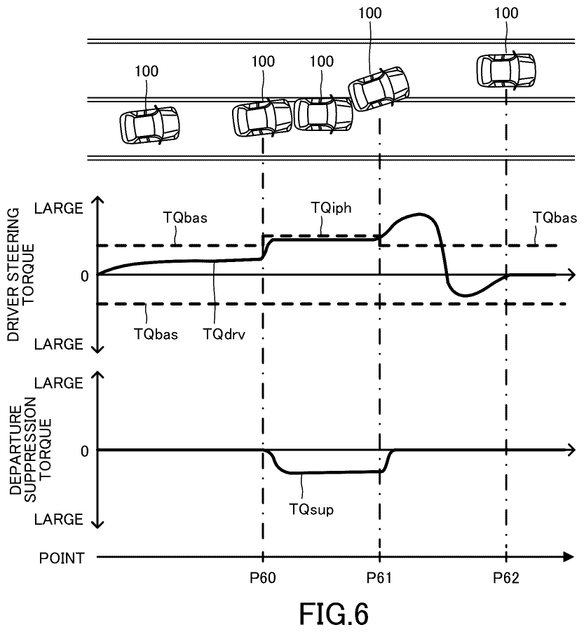

Further, a scene shown in FIG. 6 is a scene in which the driver applies a counterclockwise steering torque to the steering wheel 31 in order to change a lane of the own vehicle 100. In the present example, the departure suppression control is started when the own vehicle 100 reaches a point P60. Accordingly, since the clockwise departure suppression torque TQsup is added to the steering column 32, the driver increases the counterclockwise steering torque applied to the steering wheel 31.

At this time, according to the vehicle driving assistance apparatus 10, when the departure suppression control is started at the point P60, the opposite-phase prohibition torque threshold TQoph is set as the counterclockwise prohibition torque threshold TQccw. That is, the counterclockwise prohibition torque threshold TQccw is increased. Therefore, the prohibition condition C3 is less likely to be satisfied. Accordingly, the departure suppression control is continued.

Then, thereafter, the driver further increases the counterclockwise driver steering torque TQdrv in order to move the own vehicle 100 from the own vehicle traveling lane LN to an adjacent lane. Accordingly, when the own vehicle 100 reaches a point P61, the counterclockwise driver steering torque TQdrv becomes equal to or greater than the prohibition torque threshold TQthr, the prohibition condition C3 is satisfied, and the departure suppression control is stopped. Accordingly, the departure suppression torque TQsup becomes zero. It should be noted that, in the example shown in FIG. 6, the lane change of the own vehicle 100 is completed when the own vehicle 100 reaches a point P62.

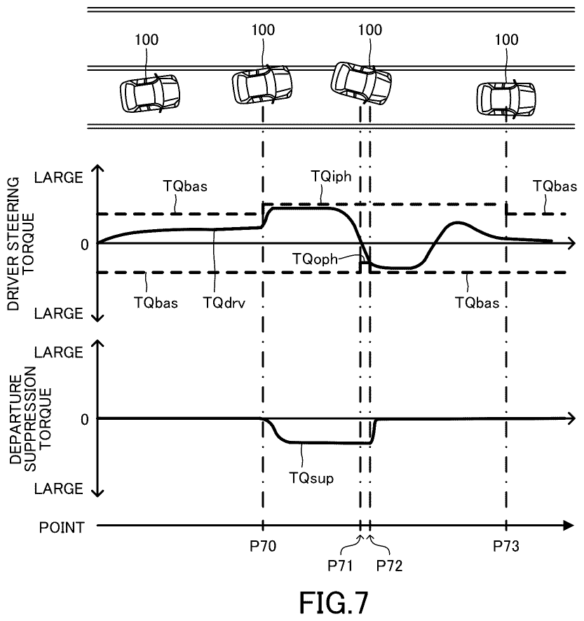

Further, a scene shown in FIG. 7 is a scene in which the driver unconsciously applies a counterclockwise steering torque to the steering wheel 31. In the present example, the departure suppression control is started when the own vehicle 100 reaches a point P70. Accordingly, since the clockwise departure suppression torque TQsup is added to the steering column 32, the driver unconsciously increases the counterclockwise steering torque applied to the steering wheel 31.

At this time, when the reference prohibition torque threshold TQbas is set as the counterclockwise prohibition torque threshold TQccw, the prohibition condition C3 is satisfied and the departure suppression control is stopped. In this case, since the counterclockwise driver steering torque TQdrv is increased, there is a possibility that the own vehicle 100 largely departs from the own vehicle traveling lane LN.

However, according to the vehicle driving assistance apparatus 10, when the departure suppression control is started at the point P70, the opposite-phase prohibition torque threshold TQoph is set as the counterclockwise prohibition torque threshold TQccw. That is, the counterclockwise prohibition torque threshold TQccw is increased. Therefore, the prohibition condition C3 is less likely to be satisfied, and the departure suppression control is continued. Accordingly, it is possible to suppress the own vehicle 100 from largely departing from the own vehicle traveling lane LN.

Then, in the example shown in FIG. 7, thereafter, the driver notices that there is a possibility that the own vehicle 100 departs from the own vehicle traveling lane LN, and starts to apply a clockwise steering torque to the steering wheel 31. Then, when the own vehicle 100 reaches a point P71, the driver steering torque TQdrv becomes a clockwise steering angle. Therefore, the in-phase prohibition torque threshold TQiph is set as the clockwise prohibition torque threshold TQcw. That is, the clockwise prohibition torque threshold TQcw is decreased. Therefore, the prohibition condition C3 is likely to be satisfied.

Then, when the own vehicle 100 reaches a point P72, the clockwise driver steering torque TQdrv becomes equal to or greater than the prohibition torque threshold TQthr set for the clockwise driver steering torque TQdrv. Therefore, the prohibition condition C3 is satisfied before the end condition C4 is satisfied. Therefore, the departure suppression control is stopped, and thereafter, the departure suppression torque TQsup becomes zero. Further, when the prohibition condition C3 is satisfied, the reference prohibition torque threshold TQbas is set as the counterclockwise prohibition torque threshold TQccw.

It should be noted that, in the example shown in FIG. 7, thereafter, when the own vehicle 100 reaches a point P73, the own vehicle 100 is returned to the center of the own vehicle traveling lane LN by an operation of the steering wheel 31 by the driver.

As described above, according to the vehicle driving assistance apparatus 10, a value of the prohibition torque threshold TQthr is different among a case where the departure suppression control is not executed, a case where the departure suppression control is executed and the driver steering torque TQdrv and the departure suppression torque TQsup are steering torques in opposite directions, and a case where the departure suppression control is executed and the driver steering torque TQdrv and the departure suppression torque TQsup are steering torques in the same direction. Therefore, according to a situation, the departure suppression control can be continued or stopped. Accordingly, execution and continuation of the departure suppression control and stopping of the departure suppression control can be appropriately performed.

It should be noted that the present invention is not limited to the above-described embodiment, and various modifications can be employed within the scope of the present invention.

What is claimed is:

1. A vehicle driving assistance apparatus comprising an electronic control unit which executes a departure suppression control of suppressing a departure of an own vehicle from a traveling lane by autonomously inputting, to a steering mechanism of the own vehicle, a departure suppression torque which is a steering torque in a direction opposite to an operator steering torque input to the steering mechanism by an operator of the own vehicle,
the electronic control unit being configured to:
not execute the departure suppression control when the operator steering torque becomes equal to or greater than a predetermined prohibition torque threshold while the departure suppression control is not executed, even when there is a possibility that the own vehicle departs from the traveling lane; and
stop the departure suppression control when the operator steering torque becomes equal to or greater than the predetermined prohibition torque threshold while the departure suppression control is executed,
wherein the electronic control unit is configured to:
set a reference prohibition torque threshold as the predetermined prohibition torque threshold when the departure suppression control is not executed;
set a first prohibition torque threshold as the predetermined prohibition torque threshold applied to the operator steering torque in a direction opposite to the departure suppression torque when the departure suppression control is executed, and the operator steering torque is a steering torque in a direction opposite to the departure suppression torque; and
set a second prohibition torque threshold as the predetermined prohibition torque threshold applied to the operator steering torque in the same direction as the departure suppression torque when the departure suppression control is executed, and the operator steering torque is a steering torque in the same direction as the departure suppression torque, and
wherein the reference prohibition torque threshold, the first prohibition torque threshold, and the second prohibition torque threshold are set to different values from each other.

2. The vehicle driving assistance apparatus according to claim 1,
wherein the first prohibition torque threshold is set to a value larger than the reference prohibition torque threshold, and
wherein the second prohibition torque threshold is set to a value smaller than the reference prohibition torque threshold.

3. A vehicle driving assistance method of executing a departure suppression control of suppressing a departure of an own vehicle from a traveling lane by autonomously inputting, to a steering mechanism of the own vehicle, a departure suppression torque which is a steering torque in a direction opposite to an operator steering torque input to the steering mechanism by an operator of the own vehicle,
the vehicle driving assistance method comprising steps of:
not executing the departure suppression control when the operator steering torque becomes equal to or greater than a predetermined prohibition torque threshold while the departure suppression control is not executed, even when there is a possibility that the own vehicle departs from the traveling lane; and
stopping the departure suppression control when the operator steering torque becomes equal to or greater than the predetermined prohibition torque threshold while the departure suppression control is executed,
wherein the vehicle driving assistance method further comprises steps of:
setting a reference prohibition torque threshold as the predetermined prohibition torque threshold when the departure suppression control is not executed;
setting a first prohibition torque threshold as the predetermined prohibition torque threshold applied to the operator steering torque in a direction opposite to the departure suppression torque when the departure suppression control is executed, and the operator steering torque is a steering torque in a direction opposite to the departure suppression torque; and
setting a second prohibition torque threshold as the predetermined prohibition torque threshold applied to the operator steering torque in the same direction as the departure suppression torque when the departure suppression control is executed, and the operator steering torque is a steering torque in the same direction as the departure suppression torque, and
wherein the reference prohibition torque threshold, the first prohibition torque threshold, and the second prohibition torque threshold are set to different values from each other.

4. A computer-readable non-transitory storage medium storing a vehicle driving assistance program which executes a departure suppression control of suppressing a departure of an own vehicle from a traveling lane by autonomously inputting, to a steering mechanism of the own vehicle, a departure suppression torque which is a steering torque in a direction opposite to an operator steering torque input to the steering mechanism by an operator of the own vehicle,
the vehicle driving assistance program being configured to:
not execute the departure suppression control when the operator steering torque becomes equal to or greater than a predetermined prohibition torque threshold while the departure suppression control is not executed, even when there is a possibility that the own vehicle departs from the traveling lane; and
stop the departure suppression control when the operator steering torque becomes equal to or greater than the predetermined prohibition torque threshold while the departure suppression control is executed,
wherein the vehicle driving assistance program is configured to:
set a reference prohibition torque threshold as the predetermined prohibition torque threshold when the departure suppression control is not executed;
set a first prohibition torque threshold as the predetermined prohibition torque threshold applied to the operator steering torque in a direction opposite to the departure suppression torque when the departure suppression control is executed, and the operator steering torque is a steering torque in a direction opposite to the departure suppression torque; and
set a second prohibition torque threshold as the predetermined prohibition torque threshold applied to the operator steering torque in the same direction as the departure suppression torque when the departure suppression control is executed, and the operator steering torque is a steering torque in the same direction as the departure suppression torque, and
wherein the reference prohibition torque threshold, the first prohibition torque threshold, and the second prohibition torque threshold are set to different values from each other.
